(19) United States
(12) Patent Application Publication
(10) Pub. No.: US 2017/0291439 A1
(43) Pub. Date: Oct. 12, 2017

(54) PRINTING DEVICE AND PRINTING METHOD

(71) Applicant: TOSHIBA TEC KABUSHIKI KAISHA, Tokyo (JP)

(72) Inventor: Minoru KOYATA, Mishima Shizuoka (JP)

(21) Appl. No.: 15/427,635

(22) Filed: Feb. 8, 2017

(30) Foreign Application Priority Data
Apr. 8, 2016 (JP) 2016-078285

(51) Int. Cl. B41J 29/38; B64D 1/00; B64D 47/08; B64C 39/02

(52) U.S. Cl. CPC B41J 29/38; B64C 39/024; B64D 1/00; B64D 47/08; B64C 2201/12; B64C 2201/027; B64C 2201/108; B64C 2201/141

(57) ABSTRACT

A printing device includes a printer, a flying object having the printer attached thereto, an image capturing device, and a control unit configured to control the flying object to move the printer to printing positions according to a shape of an object recognized from an image captured by the image capturing device and the printer to print on a printing surface of the object as the printer is moved to the printing positions.

### CROSS-REFERENCE TO RELATED APPLICATION

This application is based upon and claims the benefit of priority from Japanese Patent Application No. 2016-078285, filed Apr. 8, 2016, the entire contents of which are incorporated herein by reference.

### FIELD

Embodiments described herein relate generally to a printing device and a printing method.

### BACKGROUND

In the related art, there is a printing system for performing printing on a metal or plastic plate having a fixed thickness or a medium having irregularities of approximately several millimeters. However, the printing system of the related art is unable to perform printing on a three-dimensional object having a printing surface with irregularities of several tens of millimeters or more or having a complicated shape. The printing system of the related art is unable to perform direct printing on an elevated spot at a height of several meters to several tens of meters from the ground.

### DESCRIPTION OF THE DRAWINGS

FIG. 1 is a front view illustrating an example of a printing device according to an embodiment.

FIG. 2 is a side view illustrating an example of the printing device according to an embodiment.

FIG. 3 is a block diagram illustrating an example configuration of a control system in a printing device according to an embodiment.

FIG. 4 is a flowchart depicting a first printing process in the printing device according to an embodiment.

FIG. 5 is a flowchart depicting a second printing process in the printing device according to an embodiment.

FIG. 6 is a flowchart depicting a modified example of the second printing process in the printing device according to an embodiment.

### DETAILED DESCRIPTION

According to one embodiment, there is provided a printing device and a printing method capable of performing printing on a three-dimensional object or an elevated spot.

In general, according to an embodiment, a printing device includes a printer, a flying object having the printer attached thereto, an image capturing device, and a control unit configured to control the flying object to move the printer to printing positions according to a shape of an object recognized from an image captured by the image capturing device and the printer to print on a printing surface of the object as the printer is moved to the printing positions.

In the following, embodiments will be described in detail with reference to drawings.

A printing device according to the embodiment includes a flying object mounted with a printing mechanism. The printing device prints an image on a surface of a printing target while flying in the air. For example, the printing device prints an image on a plurality of surfaces in a three-dimensional object, a wall surface at an elevated spot, or the like. The flying object mounted with the printing unit is an airplane flying by unmanned autonomous control or remote control. In an embodiment, the flying object is a drone.

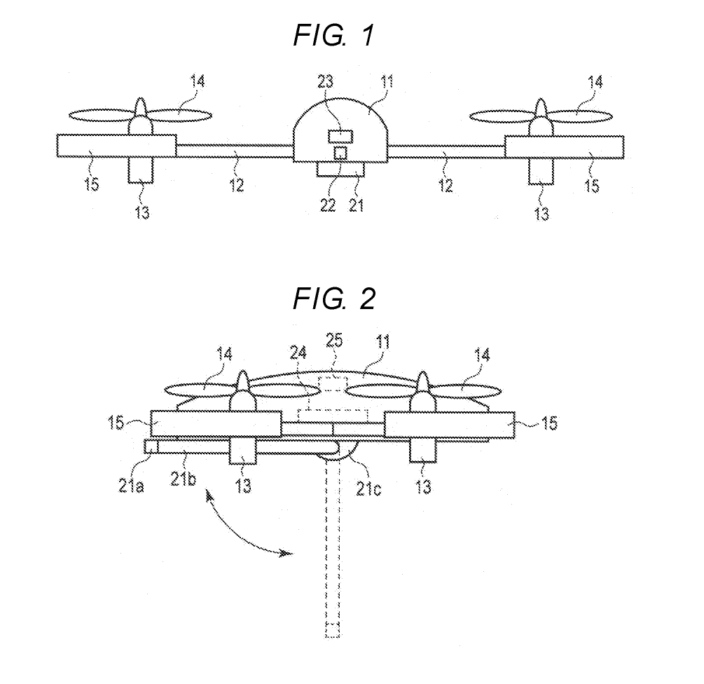

FIG. 1 and FIG. 2 are diagrams schematically illustrating an embodiment of the printing device 1. FIG. 1 is a front view of the printing device 1 and FIG. 2 is a side view of the printing device 1.

The printing device 1 includes a main body 11, four support arms 12, four propulsion units 13, four propellers 14, a bumper 15, a printing unit 21, a camera (image capturing unit) 22, a distance sensor 23, a posture sensor 24, and a position sensor 25. The support arms 12, the propulsion units 13, and the propellers 14 are propulsion devices (flight mechanisms) for flying. That is, the printing device 1 is configured by mounting a printing mechanism on a flying object (e.g., multi-copter) including a plurality of propulsion devices. In the example shown in FIG. 1, the printing device 1 is configured by mounting a printing unit, various sensors, and control units (controllers) on a main body of a quad-copter including four propulsion devices.

Four support arms 12, the printing unit 21, the camera 22, the distance sensor 23, the posture sensor 24, the position sensor 25, and the like are attached to the main body 11. The main body 11 includes a control unit controlling respective units. The control unit mounted on the main body 11 has a flight control function controlling flight of the printing device 1, a printing control function controlling printing to an object, various operation processing functions, and the like.

Four support arms 12 radially extend from the main body 11. Each support arm 12 holds each propulsion unit 13. Each propulsion unit 13 includes a motor. In each propulsion unit 13, each propeller 14 is attached to the motor. Each propulsion unit 13 rotates each propeller 14 using the motor. The propellers 14 extend within a horizontal plane above the support arms 12. The main body 11 is flown by four propellers 14 rotated by the propulsion units 13 attached to the support arms 12. Lower sides of the propulsion units 13 function as a landing device that lands on the ground when the propellers 14 stop.

Bumpers 15 for protecting the propellers 14 are provided in the support arms 12. Each bumper 15 extends over a rotation area of each propeller 14. The bumpers 15 mainly prevent the propellers 14 from colliding with an object at a front side or a lateral side. The bumper 15 is formed outside a photographing field of view of the camera 22 and to avoid disturbing the measurement by each sensor.

The printing unit 21 includes a printing head 21a, a support arm 21b, and an arm driving mechanism 21c (also referred to as an “arm driving actuator”). The printing head 21a is a unit that prints an image on a surface at a predetermined direction (front side). The printing head 21a needs to print an image on a surface at a predetermined direction. In an embodiment, the printing head 21a is an inkjet head unit and, for purposes of clarity by example, is described as such herein. The printing head 21a as the inkjet head unit ejects ink supplied from an ink tank from a nozzle. The printing head 21a is attached to the tip of the support arm 21b.

The support arm 21b is rotated by the arm driving mechanism 21c. The arm driving mechanism 21c drives a position of the support arm 21b to thereby set the nozzle of the printing head 21a to a direction in which ink is ejected. That is, a printing position of the printing device 1 is determined by a position and a direction of the main body 11 and a position of the support arm 21b to which the printing head 21a is attached.

The printing head 21a or the support arm 21b to which the printing head 21a is attached may also be fixed to the main body 11. When the printing head 21a or the support arm 21b is fixed to the main body 11, a direction in which ink is ejected by the printing head 21a is adjusted by the direction of the main body 11.

The camera (image capturing unit) 22 captures an image. The camera 22 captures an image of a surface of an object that becomes a printing target. The camera 22 continuously captures an image by a desired frame rate. The image-capturing direction of the camera 22 may also be fixed or movable with respect to the main body 11.

The distance sensor 23 measures a distance to an object. The distance sensor 23 measures a distance to a surface, which becomes a printing surface, of an object. The distance sensor 23 may also be attached to the main body 11 or attached to the support arm 21b. The control unit of the main body 11 detects a distance between the printing head 21a and the printing surface (surface of object) at the front side of the printing head 21a in the ink ejection direction based on a distance to be measured by the distance sensor 23.

The posture sensor 24 detects a posture of the main body 11. For example, the posture sensor 24 detects an inclination with respect to a horizontal plane. The posture sensor 24 is provided in the main body 11. The posture sensor 24 may also be attached to the support arm 21b. The control unit of the main body 11 detects a direction of the main body 11 based on the posture detected by the posture sensor 24.

The position sensor 25 detects a position of the main body 11. For example, the position sensor 25 detects the position of the main body 11 in a three-dimensional space. The position sensor 25 may also detect a position by the Global Positioning System (GPS) or the like or a sensor detecting a position from a relative positional relationship with respect to a predetermined target. The position sensor 25 is provided in the main body 11. The position sensor 25 may also be provided in the vicinity of the printing head 21a to detect a position of the printing head 21a. The control unit of the main body 11 detects a flight position and a printing position based on the position to be detected by the position sensor 25.

Next, an example configuration of a control system in the printing device 1 will be described.

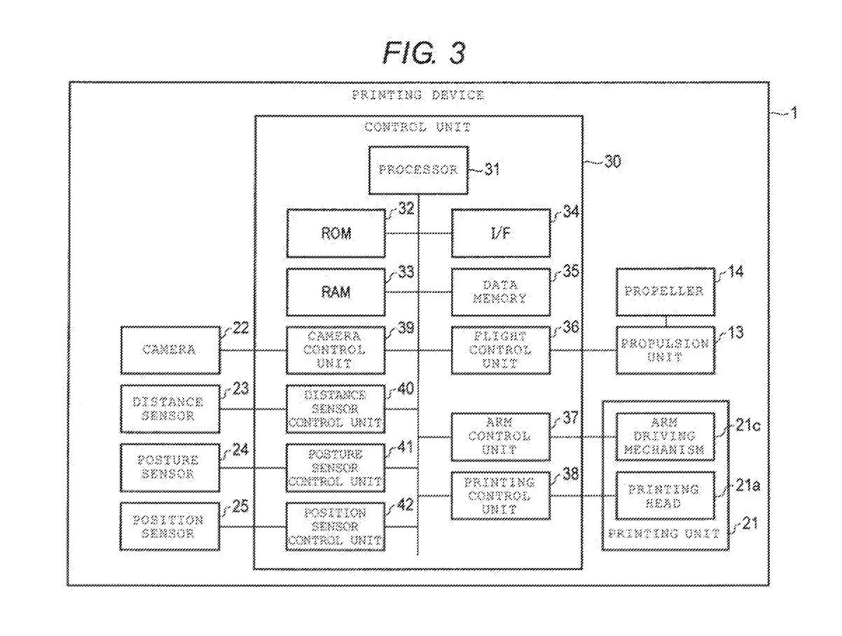

FIG. 3 is a block diagram illustrating an example configuration of the control system in the printing device 1.

As illustrated in FIG. 3, the printing device 1 includes a control unit 30 connected to the propulsion unit 13, the printing unit 21, the camera 22, the distance sensor 23, the posture sensor 24, and the position sensor 25. The control unit 30 includes a processor 31, a read-only memory (ROM) 32, a random access memory (RAM) 33, an interface (I/F) 34, a data memory 35, a flight control unit 36, an arm control unit 37, a printing control unit 38, a camera control unit 39, a distance sensor control unit 40, a posture sensor control unit 41, and a position sensor control unit 42.

The processor 31 is, for example, a central processing unit (CPU). The processor 31 includes a circuit that executes operation processing according to a program. The processor 31 executes a program stored in the ROM 32 or the data memory 35 to thereby achieve various processing functions described herein. The RAM 33 is a working memory. The RAM 33 is, for example, a volatile memory. A program to be executed is read into the RAM 33 or the RAM 33 functions as a buffer memory. The ROM 32 is a program memory. The ROM 32 is, for example, an un-rewritable nonvolatile memory.

For example, the processor 31 has a shape recognition function for recognizing a shape of an object (printing surface) based on an image to be captured by the camera 22 and a distance to be measured by the distance sensor 23. The processor 31 has a function for determining a three-dimensional printing position based on an image to be printed and a shape of the printing surface. The processor 31 has a function for determining the position and the direction of the main body 11 and the position of the support arm 21b in accordance with the three-dimensional printing position.

The I/F 34 is an interface for inputting and outputting data. The I/F 34 transmits and receives data to and from an external device. The I/F 34 can connect with the external device through a communication line or may also be a wireless communication unit. The data memory 35 stores various pieces of data. The data memory 35 is, for example, a rewritable nonvolatile memory. The data memory 35 stores a program, control data, and setting information. For example, the data memory 35 stores printing data including image information input through the I/F 34. The data memory 35 stores control data relating to flight control and printing control.

The flight control unit 36 controls flight. The flight control unit 36 controls driving of each propeller 14 by each propulsion unit 13. The flight control unit 36 may be implemented by execution of a program by the processor 31 or may be implemented using dedicated hardware. The flight control unit 36 controls each propulsion unit 13 such that the main body 11 is located at a position designated by the processor 31. The flight control unit 36 controls each propulsion unit 13 based on the posture of the main body 11 detected by the posture sensor 24 such that the main body 11 takes a desired posture.

The arm control unit 37 controls the position of the support arm 21b. The arm control unit 37 controls driving of the support arm 21b by the arm driving mechanism 21c. The arm control unit 37 controls the arm driving mechanism 21c such that the support arm 21b is located at a position designated by the processor 31.

The printing control unit 38 controls printing. The printing control unit 38 controls the timing at which the printing head 21a of the printing unit 21 ejects ink. The printing control unit 38 may be implemented by execution of a program by the processor 31 or may be implemented using dedicated hardware. For example, the printing control unit 38 controls the printing head 21a such that ink is ejected according to the printing image from the printing start position designated by the processor 31 to thereby print the image on the printing surface.

The camera control unit 39 controls the camera 22. The camera control unit 39 instructs the camera 22 to capture an image and acquires the image captured by the camera 22. The camera control unit 39 captures an image by the camera 22 at the image-capturing timing designated by the processor 31. The camera control unit 39 acquires a captured image from the camera 22 and supplies the image to the processor 31.

The distance sensor control unit 40 controls the distance sensor 23. The distance sensor control unit 40 measures a distance to an object by the distance sensor 23 and acquires information indicating the measured distance. The distance sensor control unit 40 measures the distance to the object by the distance sensor 23 at the image-capturing timing designated by the processor 31. The distance sensor control unit 40 acquires information indicating the distance measured by the distance sensor 23.

The posture sensor control unit 41 controls the posture sensor 24. The posture sensor control unit 41 detects the posture of the main body 11 by the posture sensor 24. The posture sensor control unit 41 acquires information indicating an inclination with respect to a horizontal plane of the main body 11 from the posture sensor 24. The posture sensor control unit 41 acquires information indicating the inclination of the main body 11 to be detected by the posture sensor 24 at the image-capturing timing designated by the processor 31. The posture sensor control unit 41 detects the posture of the main body 11 by information indicating the inclination of the main body 11 measured by the posture sensor 24.

The position sensor control unit 42 controls the position sensor 25. The position sensor control unit 42 detects the position of the main body 11 by the position sensor 25. The position sensor control unit 42 acquires information indicating a position in the three-dimensional space of the main body 11 from the position sensor 25. The position sensor control unit 42 acquires information indicating the position of the main body 11 to be detected by the position sensor 25 at the timing designated by the processor 31. The position sensor control unit 42 supplies the information indicating the position of the main body 11 detected by the position sensor 25 to the processor 31.

Next, a printing process in the printing device 1 will be described.

The printing device 1 configured as described above is able to print an image on a printing surface in various three-dimensional objects by ejecting ink while flying. For example, the printing device 1 is able to achieve a function (first printing process) for printing an image on a wall surface, a roof, or a ceiling located at an elevated spot, or a group of surfaces (for example, the side surface of stair) in a specific direction in a structure (object). The printing device 1 is able to achieve a function (second printing process) for printing an image on a plurality of surfaces of the three-dimensional object.

First, a process (first printing process) of printing an image on the printing surface such as a wall surface, a roof, a ceiling, or the like by the printing device 1 will be described.

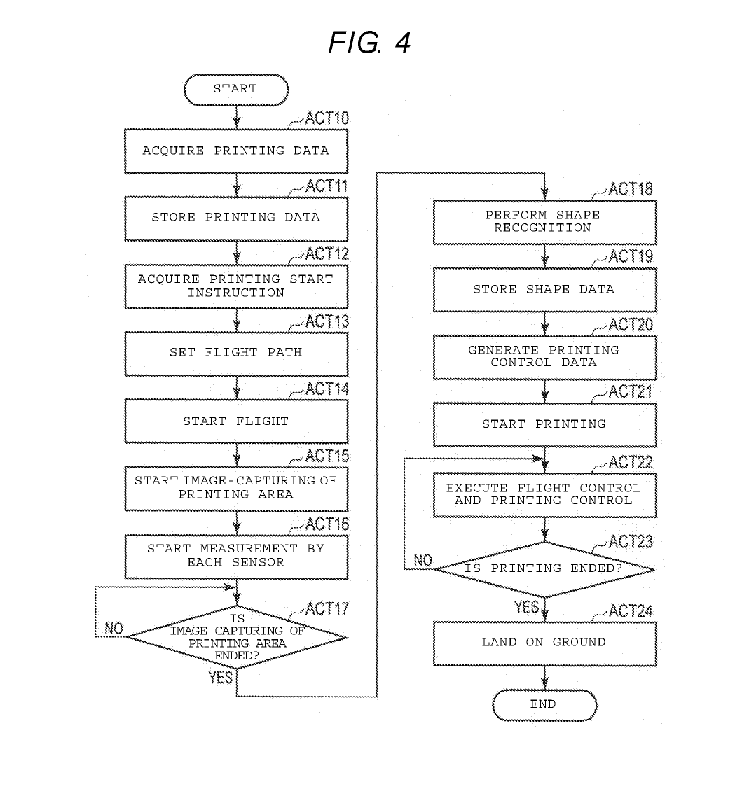

FIG. 4 is a flowchart depicting a process of printing an image on a wall surface by the printing device 1.

The processor 31 of the printing device 1 acquires printing data to be printed on the wall surface through the I/F 34 (ACT10). The printing data is input through the I/F from an external device, for example, an information terminal such as a personal computer (PC) or a smart phone. The printing data includes various information, such as an image (printing image) to be printed, information indicating a printing position, print setting information, and the like.

The information indicating the printing position may also be information indicating a printing start position in the wall surface or information indicating a printing area in the wall surface. The print setting information includes printing magnification or the like of a printing image. When the printing data is acquired through the I/F 34, the processor 31 stores the acquired printing data in the data memory 35 (ACT11).

After the printing data is acquired, the processor 31 receives a printing start instruction (ACT12). When the printing start instruction is received, the processor 31 sets a flight area (flight path) in the flight control unit 36 based on the printing position included in the stored printing data (ACT13). The processor 31 determines a flight path along which an image of a printing surface (for example, wall surface) of an object, which becomes at least a printing target area, is able to be captured by the camera 22. When the flight path is set, the processor 31 starts flight in the set flight path by the flight control of the flight control unit 36 (ACT14).

When the flight is started, the processor 31 starts image-capturing by the camera 22 through the camera control unit 39 (ACT15). The processor 31 starts a measurement by the distance sensor 23, the posture sensor 24, and the position sensor 25 through respective sensor control units 40, 41, and 42 (ACT16). The processor 31 records the captured image of the camera 22 and measurement values of respective sensors in the RAM 33 or the like while flying through the flight path.

When the image-capturing and the measurement of a printing target area are ended (YES in ACT17), the processor 31 performs shape recognition processing of recognizing a shape of the printing target area (ACT18). That is, the processor 31 recognizes a shape (irregularities or the like) of the printing target area (printing surface of object) by the image captured by the camera 22 and measurement values measured by respective sensors 23, 24, and 25.

The shape recognition processing may also be performed with only the image to be captured by the camera 22. When the shape is recognized using only the image to be captured by the camera 22, control of the measurement by respective sensors 23, 24, and 25 in ACT16 may also be omitted.

The shape recognition processing may also be executed by an external device capable of communication with the printing device. In this case, the processor 31 of the printing device 1 is intended to be configured so that the processor 31 requests the external device, which communicates through the I/F 34 (for example, a wireless communication unit is included), to perform the shape recognition processing. That is, the processor 31 may have a configuration in which the processor 31 transfers the image captured by the camera 22 and measurement values measured by respective sensors 23, 24, and 25 to the external device and acquires a shape recognition result based on data transferred from the external device. With this, the advanced shape recognition processing of which a processing load is large is able to be performed by being distributed to the external device and processing by the printing device 1 is able to be reduced.

When the shape of the printing target area is recognized, the processor 31 stores data (shape data) indicating the shape of the printing target area obtained as a recognition result in the data memory 35 (ACT19). The processor 31 generates printing control data by using printing data and shape data after the shape data is stored in the data memory 35 (ACT20). The printing control data includes information for flight control and information for printing control. The information for the flight control includes information indicating a flight path along which the printing unit 21 is able to print the printing image on the printing target area. The information for the printing control includes information, which indicates information to be printed by the printing unit 21 at respective positions in the flight path, or the like.

Generating of printing control data may also be executed by an external device capable of communication with the printing device. In this case, the processor 31 of the printing device 1 may have a configuration in which the processor 31 requests the external device to generate printing control data through the I/F 34 and acquires the printing control data from the external device.

When the printing control data is generated, the processor 31 sets the generated printing control data in the flight control unit and in the printing control unit 38 and starts printing (ACT21). For example, the processor 31 sets information for flight control included in the printing control data in the flight control unit 36. The processor 31 sets information for printing control in the printing control unit 38. When the printing control data is set, the processor 31 instructs the flight control unit 36 and the printing control unit 38 in which the printing control data is set to start printing.

When instruction to start printing is issued, the processor 31 executes flight control by the flight control unit 36 and printing control by the printing control unit 38 until printing is ended (ACT22). That is, the flight control unit 36 controls a flight posture while flying along the set flight path such that the printing unit 21 is located at a position at which printing is able to be performed on a printing area of a surface of a three-dimensional object. For example, the flight control unit 36 controls flight based on a distance to an object to be measured by the distance sensor 23 such that the printing head 21a is located at a position at which printing is able to be performed on a printing surface (wall surface).

The flight control unit 36 controls flight based on a direction of the main body 11 to be measured by the posture sensor 24 such that the direction of the printing head 21a is a direction in which printing is able to be performed on the printing surface (wall surface). The flight control unit 36 controls the flight path such that the position to be measured by the position sensor 25 moves along the flight path.

The arm control unit 37 controls the arm driving mechanism 21c such that the printing head 21a is located at a position designated by the processor 31. The printing control unit 38 controls the printing head 21a such that the printing unit 21 flying in a state capable of printing on the wall surface prints a printing image at the designated printing position. As a result, the printing image designated by the printing data is printed at the designated printing position on the wall surface.

When printing control based on printing control data is ended, the processor 31 ends printing processing for printing data (YES in ACT23). When the printing processing is ended, the processor 31 performs processes of flying to a predetermined landing position (for example, take-off position) and then, being landed on the ground (ACT24).

According to the first printing processing as described above, the printing device acquires printing data and then, recognizes a shape of a printing target area (wall surface) by an image captured by a camera provided in a main body flying in an autonomous manner. The printing device generates the printing control data used for printing the printing image, which is designated by printing data, on the printing target area according to the shape of the printing target area obtained as the result of shape recognition. The printing device controls flight and printing based on the generated printing control data.

With this, the printing device according to the embodiment is able to easily print an image on the printing target area such as a wall surface, a roof, or a ceiling located at an elevated spot. In the printing device according to the embodiment, the printing device performs printing while flying and thus, it is possible to perform printing even on a large printing area (wall surface, roof, ceiling, or the like) by a small printing device.

Next, a modified example of the first printing process will be described.

The printing device 1 is able to achieve control of printing an image on a group of surfaces in a specific direction in a structure (object) such as a side surface of a stair, as the modified example of the first printing process described above. For example, it is assumed that process of printing an image on the side surface when the stair is viewed from the front side is performed by the printing device 1. That is, the processor 31 of the printing device 1 executes the first printing process by setting the entire surface including a plurality of side surfaces as the printing target area when the stair is viewed from the front side.

In this case, the camera 22 captures an image of respective side surfaces of the stair in ACT15 and respective sensors 23, 24, and 25 perform the measurement with respect to respective side surfaces of the stair in ACT16. Furthermore, the processor 31 performs the shape recognition with respect to the entire surface including a plurality of side surfaces of the stair in ACT18 and ACT19 and stores shape data as the recognition result. According to the shape data, the processor 31 is able to perform the printing by setting the entire surface including the plurality of side surfaces of the stair as the printing target area through printing processing in ACT20 to ACT23.

According to the modified example described above, the printing device 1 is able to print a single printing image by setting a plurality of side surfaces of the stair as the printing surface. As a result, the printing device easily performs printing processing having an effect that the image printed on the plurality of side surfaces can be visually recognized as a single printing image when the stair is viewed from the front side.

Next, a process (second printing process) of printing an image on a surface of a three-dimensional object by the printing device 1 will be described.

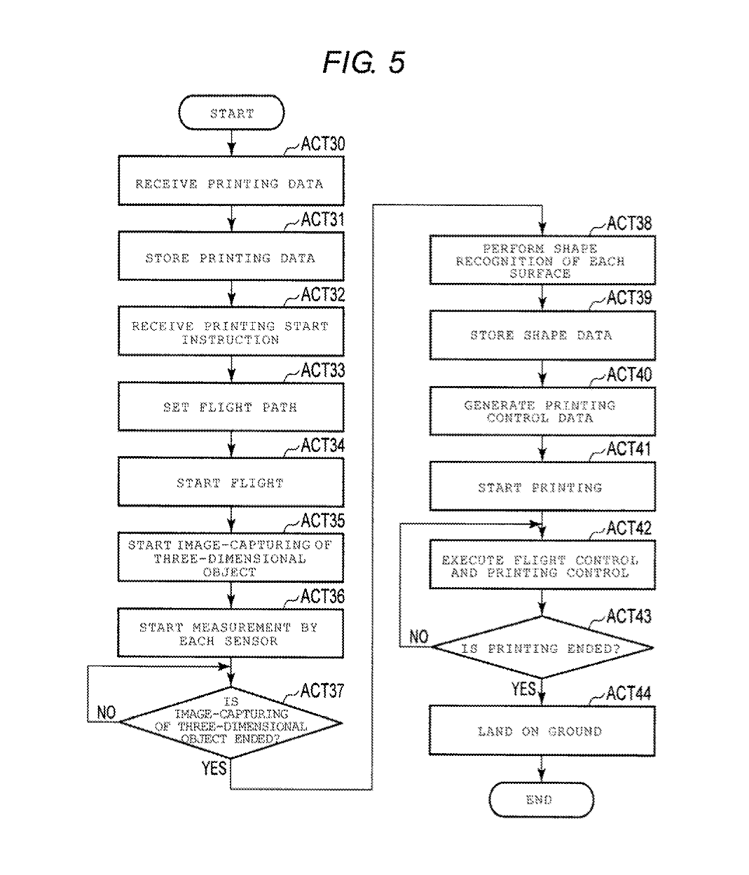

FIG. 5 is a flowchart depicting a process of printing an image on a surface of a three-dimensional object by the printing device 1.

The processor 31 of the printing device 1 acquires printing data indicating printing contents for the surface of the three-dimensional object including a plurality of surfaces from the external device through the I/F 34 (ACT30). When the printing data is acquired through the I/F 34, the processor 31 stores the acquired printing data in the data memory 35 (ACT31).

The printing data is input through the I/F 34 from an external device, for example, an information terminal such as a PC or a smart phone. The user instructs a printing image to be printed on the surface of the three-dimensional object, a printing position, setting of printing, and the like by an application for performing setting of printing for the three-dimensional object in the external device. When the user issues an instruction, the external device generates printing data including information indicating the printing image, the printing position, and the setting of printing. The information indicating the printing position is information indicating whether the printing image is to be printed on each surface of the three-dimensional object. The information indicating the printing position is, for example, information indicating a printing area or information indicating a printing start position. Here, the printing position on the surface of the three-dimensional object may also be designated based on design data of the three-dimensional object and designated by a position coordinate or the like.

After the printing data is acquired, the processor 31 receives a printing start instruction (ACT32). When the printing start instruction is received, the processor 31 sets the flight path along which the image of the surface of the three-dimensional object, which becomes the printing target, can be captured by the camera 22 in the flight control unit 36 (ACT33). The flight path may also be acquired from the external device through the I/F 34.

When the flight path is set, the processor 31 performs processes of starting flying along the flight path, which is set by flight control of the flight control unit 36 (ACT34). When the flight is started, the processor 31 performs processes of starting image-capturing of the surface of the three-dimensional object by the camera 22 through the camera control unit 39 (ACT35). The processor 31 performs processes of starting the measurement by the distance sensor 23, posture sensor 24, and position sensor 25 through respective sensor control units 40, 41, and 42, together with image-capturing of the surface of the three-dimensional object (ACT36). While flying through the flight path, the processor 31 performs processes of recording the image captured by the camera 22 and measurement values of respective sensors 23, 24, and 25 in the RAM 33 or the like.

When the image-capturing and measurement of the surface of the three-dimensional object are ended (YES in ACT37), the processor 31 performs the shape recognition processing of recognizing the shape of the surface of the three-dimensional object (ACT38). The processor 31 performs processes of recognizing the shape of the surface of the three-dimensional object by using the images captured by the camera 22 and accumulated in the RAM 33 and measurement values measured by respective sensors 23, 24, and 25.

The shape recognition processing may also be performed by using only the image to be captured by the camera 22. When the shape is recognized by using only the image to be captured by the camera 22, measurement control by respective sensors 23, 24, and 25 in ACT36 may also be omitted.

The shape recognition processing may also be executed by an external device capable of being communicated with the printing device 1. In this case, the advanced shape recognition processing of which a processing load is large is able to be performed by being distributed to the external device and processing by the printing device 1 is able to be reduced.

When the shape of the three-dimensional object is recognized, the processor 31 performs processes of storing data (shape data) indicating the shape of the surface of the three-dimensional object obtained as the result of shape recognition in the data memory 35 (ACT39). After the shape data is stored in the data memory 35, the processor 31 generates printing control data by using the shape data of the three-dimensional object and the printing data (ACT40). That is, the processor 31 performs processes of generating printing control data used for printing the printing image designated by the printing data on the surface of the three-dimensional object having a shape indicated by the shape data. The printing control data includes information for flight control and information for printing control. For example, the information for the flight control includes information indicating a flight path along which the printing unit 21 is able to print the printing image on the surface of the three-dimensional object which is a printing target. The information for the printing control includes information which indicates the timing, at which the printing unit 21 prints an image on the three-dimensional object while flying through the flight path, or the like.

Generating of printing control data may also be executed by an external device capable communication with the printing device. In this case, the processor 31 of the printing device 1 may have a configuration in which the processor 31 requests the external device to generate printing control data through the I/F 34 and acquires the printing control data from the external device.

When the printing control data is generated, the processor 31 sets the generated printing control data in the flight control unit 36 and in the printing control unit 38 and starts printing (ACT41). The processor 31 performs processes of setting information for flight control included in the printing control data in the flight control unit 36. The processor 31 performs processes of setting information for printing control in the printing control unit 38. When the printing control data is set, the processor 31 performs processes of instructing the flight control unit 36 and the printing control unit 38 in which the printing control data is set to start printing.

When instruction to start printing is issued, the processor 31 performs processes of executing flight control by the flight control unit 36 and printing control by the printing control unit 38 until printing is ended (ACT42). That is, the flight control unit 36 controls a flight posture while flying along the set flight path such that the printing unit 21 is located at a position at which printing is able to be performed on a printing area of a surface of a three-dimensional object. For example, the flight control unit 36 controls flight based on a distance to an object to be measured by the distance sensor 23 such that the printing head 21a is located at a position at which printing is able to be performed on the surface of the three-dimensional object. The flight control unit 36 controls flight based on a direction of the main body 11 to be measured by the posture sensor 24 such that the direction of the printing head 21a is a direction in which printing is able to be performed on the surface of the three-dimensional object. The flight control unit 36 controls the flight path such that the position of the main body 11 to be measured by the position sensor 25 moves along the flight path.

The arm control unit 37 controls the arm driving mechanism 21c such that the printing head 21a is located at a position designated by the processor 31. The printing control unit 38 controls the printing head 21a such that the printing unit 21 flying in a state capable of printing on the surface of the three-dimensional object prints a printing image at the designated printing position. As a result, the printing image designated by the printing data is printed at the designated printing position in the surface of the three-dimensional object.

When printing control based on printing control data is ended, the processor 31 ends printing processing for printing data (YES in ACT43). When the printing processing is ended, the processor 31 performs processes of being landed at a predetermined landing position (for example, take-off position) (ACT44).

According to the second printing process as described above, the printing device acquires printing data and then, recognizes a shape of a three-dimensional object regarded as a printing target by an image captured by a camera provided in a main body flying in an autonomous manner. The printing device generates the printing control data used for printing, which is designated by printing data, at the printing position of the surface of the three-dimensional object according to the recognized shape of the surface of the three-dimensional object. The printing device prints an image on the surface of the three-dimensional object based on the generated printing control data while flying around the three-dimensional object. With this, according to the printing device, it is possible to easily print an image even on the surface of the three-dimensional object having a complicated shape. The printing device itself performs printing while flying and thus, it is possible to perform printing even on a large three-dimensional object by a small printing device.

Next, a modified example of the second printing process will be described.

The printing device 1 may also have a configuration such that the printing data indicating the printing position and the printing image based on a recognition result of the shape of the three-dimensional object is received from an external device, as the modified example of the second printing process. According to the modified example, the user is able to specifically designate where an image is to be printed and what image is to be printed for a shape of an actual three-dimensional object by a smart phone or a PC as the external device.

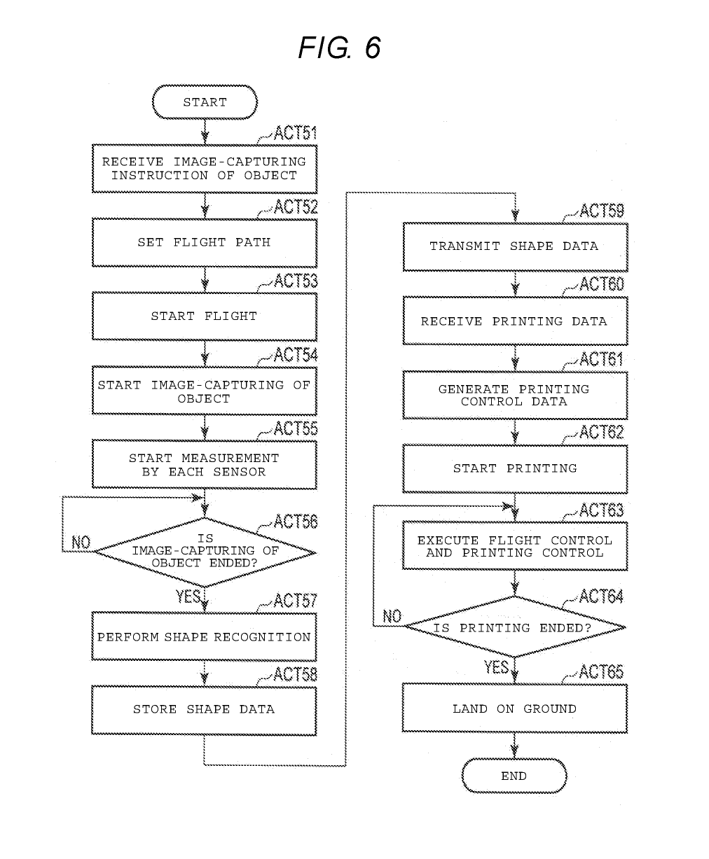

FIG. 6 is a flowchart depicting a modified example of the second printing process performed by the printing device 1.

Here, it is assumed that the external device has a function for communicating with the printing device 1. The external device is an information processing device such as a PC or a smart phone including a processor, a memory, an interface, and the like. The external device achieves various processing functions by causing the processor to execute a program. It is assumed that the external device has a function for instructing the printing device 1 to recognize the shape of the three-dimensional object and a function for supplying the printing data to the three-dimensional object, as the processing functions.

First, the processor 31 of the printing device 1 performs processes of receiving an instruction to capture an image of the three-dimensional object which becomes a shape recognition (printing) target (ACT51). When the instruction to capture the image of the three-dimensional object is received, the processor 31 performs processes of setting the flight path along which the image of the entire surface of the three-dimensional object, which becomes the shape recognition target, can be captured by the camera 22 (ACT52). The flight path may also be acquired from the external device through the I/F 34.

When the flight path is set, the processor 31 performs processes of starting flying along the flight path which is set by flight control of the flight control unit 36 (ACT53). When the flight is started, the processor 31 performs processes of starting image-capturing of the surface of the three-dimensional object by the camera 22 through the camera control unit 39 (ACT54). The processor 31 performs processes of starting the measurement by the distance sensor 23, posture sensor 24, and position sensor 25 through respective sensor control units 40, 41, and 42 (ACT55). While flying through the flight path, the processor 31 performs processes of recording the image captured by the camera 22 and measurement values of respective sensors in the RAM 33 or the like.

When the image-capturing and measurement of the surface of the three-dimensional object are ended (YES in ACT56), the processor 31 performs processes of performing the shape recognition processing of recognizing the shape of the surface of the three-dimensional object (ACT57). The processor 31 performs processes of recognizing the shape of the surface of the three-dimensional object by using the images captured by the camera 22 and measurement values measured by respective sensors 23, 24, and 25.

The shape recognition processing may also be performed by using only the image to be captured by the camera 22. When the shape is recognized by using only the image to be captured by the camera 22, the measurement control by respective sensors 23, 24, and 25 in ACT36 may also be omitted. The shape recognition processing may also be executed by the external device. When the external device executes the shape recognition processing, the printing device 1 transfers the image captured by the camera 22 and measurement values measured by respective sensors to the external device.

When the shape of the three-dimensional object is recognized, the processor 31 performs processes of storing shape data of the three-dimensional object obtained as the result of shape recognition in the data memory 35 (ACT58). The processor 31 performs processes of transmitting a result of the shape recognition to the external device (ACT59). After the result of shape recognition is transmitted, the processor 31 performs processes of receiving printing data for the three-dimensional object from the external device.

The external device acquires shape data as the result of the shape recognition for the three-dimensional object from the printing device 1. The external device receives designation about what position of the three-dimensional object an image is to be printed and what image is to be printed (printing image and printing position) based on the acquired shape data of the three-dimensional object. When the printing image and the printing position are designated, the external device generates printing data indicating the printing image and the printing position for the surface of the three-dimensional object and transmits the generated printing data to the printing device 1.

The printing device 1 receives the printing data from the external device (ACT60). When the printing data is received from the external device, the processor 31 performs processes of generating printing control data used for printing the printing image designated by the received printing data on the surface of the three-dimensional object having a shape indicated by the shape data (ACT61). The external device may also perform even generating of the printing control data.

When the printing control data is generated, the processor 31 performs processes of setting the generated printing control data in the flight control unit 36 and in the printing control unit 38 and starts printing (ACT62). When instruction to start printing is issued, the processor 31 executes flight control by the flight control unit 36 and printing control by the printing control unit 38 until printing is ended (ACT63). That is, the flight control unit 36 controls a flight posture while flying along the set flight path such that the printing unit 21 is located at a position at which printing is able to be performed on the printing area of the surface of the three-dimensional object.

The arm control unit 37 controls the arm driving mechanism 21c such that the printing head 21a is located at a position designated by the processor 31. The printing control unit 38 controls the printing head 21a such that the printing unit 21 flying in a state capable of printing on the surface of the three-dimensional object prints a printing image at the designated printing position.

When printing control based on printing control data is ended, the processor 31 performs processes of ending printing processing for printing data (YES in ACT64). When the printing processing is ended, the processor 31 performs processes of being landed at a predetermined landing position (for example, take-off position) (ACT65).

In the modified example of the second printing process, the printing device recognizes a shape of a three-dimensional object regarded as the printing target by an image captured by a camera provided in a main body flying in an autonomous manner according to an instruction from the external device. The printing device provides the shape data indicating the shape of the three-dimensional object recognized by the shape recognition processing to the external device. Furthermore, the printing device acquires the printing data corresponding to the shape data of the three-dimensional object from the external device and performs printing of an image on the surface of the three-dimensional object according to the acquired printing data. According to the modified example, it is possible to recognize the shape of the surface of the three-dimensional object, which becomes a printing target, by an actual measurement and the user is able to designate the printing image and the printing position as the result of the actual measurement of the shape of the three-dimensional object.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope of the inventions.

What is claimed is:

1. A printing device, comprising;
a printer;
a flying object having the printer attached thereto;
an image capturing device; and
a control unit configured to control the flying object to move the printer to printing positions according to a shape of an object recognized from an image captured by the image capturing device and the printer to print on a printing surface of the object as the printer is moved to the printing positions.

2. The printing device according to claim 1, further comprising:
a distance sensor configured to measure a distance to the printing surface of the object;
wherein the control unit is configured to control the flying object to move the printer to the printing positions according to the recognized shape of the object and the distance measured by the distance sensor.

3. The printing device according to claim 1,
wherein the printing surface of the object is at least one of a wall surface, a roof, and a ceiling, and
the control unit is configured to recognize a shape of the printing surface and control the flying object to move the printer to the printing positions according to the recognized shape of the printing surface.

4. The printing device according to claim 1,
wherein the object is a three-dimensional object having a plurality of surfaces that form the printing surface, and
the control unit is configured to recognize a shape of a surface of the plurality of surfaces of the three-dimensional object, and control the flying object to move the printer to the printing positions according to the recognized shape of the surface.

5. The printing device according to claim 1, wherein the flying object is a drone having a plurality of propulsion devices.

6. The printing device according to claim 5, wherein each of the plurality of propulsion devices comprises a propulsion unit and a propeller.

7. The printing device according to claim 1, wherein the printer comprises:
a support arm;
a printing head attached to the support arm; and
an arm driving actuator to move the support arm.

8. The printing device according to claim 7, wherein the printing head is an inkjet head.

9. The printing device according to claim 1, further comprising:
a posture sensor configured to detect an inclination with respect to a horizontal plane;
wherein the control unit is configured to detect a direction of a main body of the flying object based on the inclination detected by the posture sensor.

10. The printing device of claim 1, further comprising:
a position sensor configured to detect a position of a main body of the flying object in a three-dimensional space;
wherein the control unit is configured to detect a flight position and a printer position based on the position detected by the position sensor.

11. A flying object, comprising:
a main body;
a plurality of propulsion devices attached to the main body;
a printer attached to the main body;
an image capturing device attached to the main body; and
a control unit attached to the main body and configured to cause the flying object to move the printer to printing positions according to a shape of an object recognized from an image captured by the image capturing device and the printer to print on a printing surface of the object as the printer is moved to the printing positions.

12. The flying object according to claim 11, further comprising:
a distance sensor attached to the main body and configured to measure a distance to the printing surface of the object;
wherein the control unit is configured to control the flying object to move the printer to the printing positions according to the recognized shape of the object and the distance measured by the distance sensor.

13. The flying object according to claim 11,
wherein the printing surface of the object is at least one of a wall surface, a roof, and a ceiling, and
the control unit is configured to recognize a shape of the printing surface and control the flying object to move the printer to the printing positions according to the recognized shape of the printing surface.

14. The flying object according to claim 11,
wherein the object is a three-dimensional object having a plurality of surfaces that form the printing surface, and
the control unit is configured to recognize a shape of a surface of the plurality of surfaces of the three-dimensional object, and control the flying object to move the printer to the printing positions according to the recognized shape of the surface.

15. The flying object according to claim 11, wherein each of the plurality of propulsion devices comprises a propulsion unit and a propeller.

16. The flying object according to claim 1, wherein the printer comprises:
a support arm;
a printing head attached to the support arm; and
an arm driving actuator to move the support arm.

17. The flying object according to claim 16, wherein the printing head is an inkjet head.

18. The flying object according to claim 11, further comprising:
a posture sensor attached to the main body and configured to detect an inclination with respect to a horizontal plane;
wherein the control unit is configured to detect a direction of the main body based on the inclination detected by the posture sensor.

19. The flying object according to claim 11, further comprising:
a position sensor attached to the main body and configured to detect a position of the main body in a three-dimensional space;
wherein the control unit is configured to detect a flight position and a printer position based on the position detected by the position sensor.

20. A printing method, comprising:
generating a captured image of an object;
flying a printer according to a shape of the object recognized from the captured image; and
printing an image on a surface of the object as the printer is flown according to the recognized shape of the object.
